(19) United States
(12) Patent Application Publication
(10) Pub. No.: US 2014/0250960 A1
(43) Pub. Date: Sep. 11, 2014

(54) REKEYABLE LOCK

(71) Applicant: TAIWAN FU HSING INDUSTRIAL CO., LTD., Kaohsiung City (TW)

(72) Inventors: Tsung-Yu Li, Kaohsiung City (TW); Shih-Min Lu, Kaohsiung City (TW)

(73) Assignee: TAIWAN FU HSING INDUSTRIAL CO., LTD., Kaohsiung City (TW)

(21) Appl. No.: 13/860,617

(22) Filed: Apr. 11, 2013

(30) Foreign Application Priority Data
Mar. 11, 2013 (TW) 102108544

(51) Int. Cl. E05B 27/00

(52) U.S. Cl. CPC E05B 27/005
USPC 70/493

(57) ABSTRACT

A rekeyable lock includes a lock cylinder, a plug, a pin assembly and a stopper, the lock cylinder comprises a plug hole, a plurality of upper pin holes and a lower-pin-replacing hole, the plug is disposed at the plug hole, the pin assembly comprises a plurality of upper pins and a plurality of lower pins, the lower-pin-replacing hole selectively reveals the lower pins, the stopper is utilized for plugging into the lower-pin-replacing hole. When the stopper separates from the lower-pin-replacing hole, the lower-pin-replacing hole reveals the lower pins so as to replace the lower pins rapidly. When the stopper plugs into the lower-pin-replacing hole, the width of the stopper equals to that of the lower-pin-replacing hole. Otherwise, when the stopper separates from the lower-pin-replacing hole, the width of the stopper is larger than that of the lower-pin-replacing hole.

### FIELD OF THE INVENTION

The present invention is generally related to a lock, which particularly relates to the rekeyable lock with fast rekeying function.

### BACKGROUND OF THE INVENTION

A conventional lock 200 as illustrate in FIG. 15 comprises a lock cylinder 210, a plug 220, an upper pin assembly 230, a lower pin assembly 240, a plurality of elastic members 250 and a case 260. When a key of the lock 200 is used for rekeying, the following procedures are necessarily performed described as below: separating the case 260 from the lock cylinder 210; taking out the elastic members 250, the upper pin assembly 230 and the lower pin assembly 240 in sequence; installing another set of lower pin assembly into the lock 200; and eventually installing the upper pin assembly 230, the elastic members 250 and the case 260 in sequence. Therefore, the rekeying procedure for the conventional lock 200 is quite complicated and difficult.

### SUMMARY

The primary object of the present invention is to provide a rekeyable lock for replacing lower pins rapidly via lower-pin-replacing hole therefore lowering rekeying procedure and time.

A rekeyable lock in the present invention includes a lock cylinder, a plug, a pin assembly and a stopper, wherein the lock cylinder comprises a plug hole, a plurality of upper pin holes and a lower-pin-replacing hole, and the plug hole is in communication with the upper pin holes and the lower pin holes respectively. The plug is rotatably disposed in the plug hole and comprises a plurality of lower pin holes. The pin assembly comprises a plurality of upper pins and a plurality of lower pins, each of the upper pins is accommodated in each of the upper pin holes, each of the lower pins is accommodated in each of the lower pin holes, and the lower-pin-replacing hole selectively reveals the lower pins and comprises a first width. The stopper is utilized for plugging into the lower-pin-replacing hole and comprises a second width not smaller than the first width.

In this invention, when the stopper separates from the lower-pin-replacing hole, the second width of the stopper is larger than the first width of the lower-pin-replacing hole, otherwise, when the stopper plugs into the lower-pin-replacing hole, the second width of the stopper equals to the first width of the lower-pin-replacing hole. Owning to the feature mentioned above, the stopper is able to plug into the lower-pin-replacing hole. Besides, when the stopper separates from the lower-pin-replacing hole, the lower pins can be replaced rapidly therefore lowering rekeying procedure and time.

### DESCRIPTION OF THE DRAWINGS

FIG. 1 is a perspective exploded diagram illustrating a rekeyable lock in accordance with an embodiment of the present invention.

FIG. 2 is a perspective assembly diagram illustrating a rekeyable lock in accordance with the embodiment of the present invention.

FIG. 3 is a top view illustrating a stopper of the rekeyable lock separating from a lower-pin-replacing hole in accordance with the embodiment of the present invention.

FIG. 4 is a top view illustrating the rekeyable lock in accordance with the embodiment of the present invention.

FIG. 5 is a flow chart illustrating the operation method of the rekeyable lock in accordance with the embodiment of the present invention.

FIG. 6 is a lateral section view illustrating the rekeyable lock in accordance with the embodiment of the present invention.

FIG. 7 is a lateral section view illustrating the rekeyable lock in accordance with the embodiment of the present invention.

FIG. 8 is a lateral section view illustrating the rekeyable lock in accordance with the embodiment of the present invention.

FIG. 9 is a lateral section view illustrating the rekeyable lock in accordance with the embodiment of the present invention.

FIG. 10 is a lateral section view illustrating the rekeyable lock in accordance with the embodiment of the present invention.

FIG. 11 is a lateral section view illustrating the rekeyable lock in accordance with the embodiment of the present invention.

FIG. 12 is a lateral section view illustrating the rekeyable lock in accordance with the embodiment of the present invention.

FIG. 13 is a perspective exploded diagram illustrating the rekeyable lock in accordance with the embodiment of the present invention.

FIG. 14 is a lateral section view illustrating the rekeyable lock in accordance with the embodiment of the present invention.

FIG. 15 is a perspective exploded diagram illustrating a conventional lock.

### DETAILED DESCRIPTION OF THE INVENTION

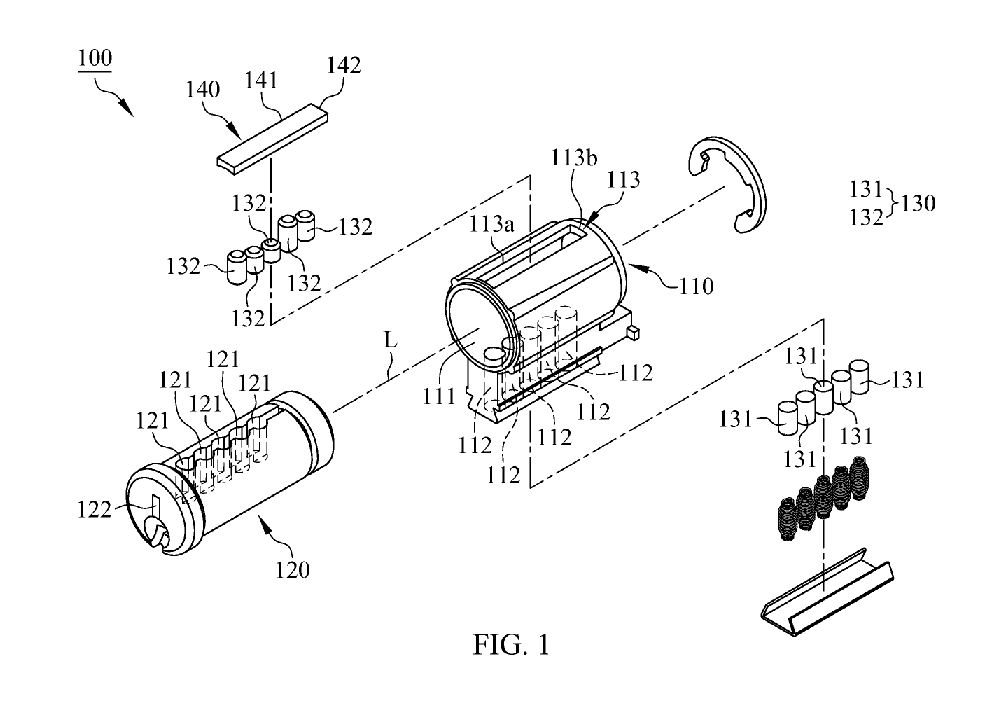

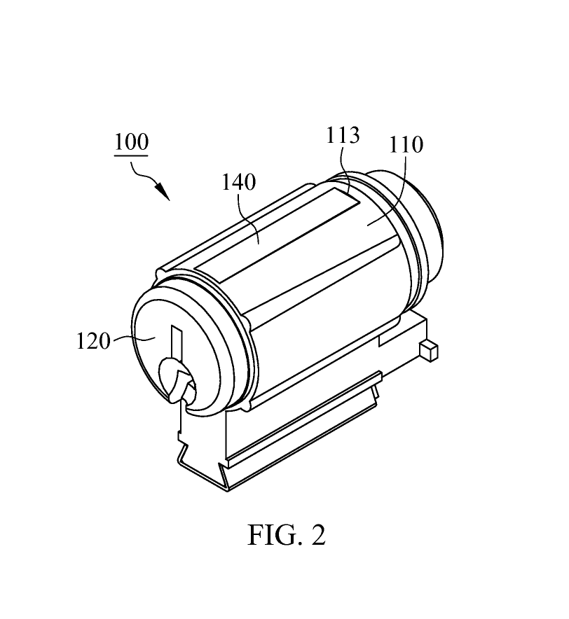

With reference to FIGS. 1, 2 and 6, a rekeyable lock in accordance with a preferred embodiment of the present invention includes a lock cylinder 110, a plug 120, a pin assembly 130 and a stopper 140, wherein the lock cylinder 110 comprises a plug hole 111, a plurality of upper pin holes 112 and a lower-pin-replacing hole 113.

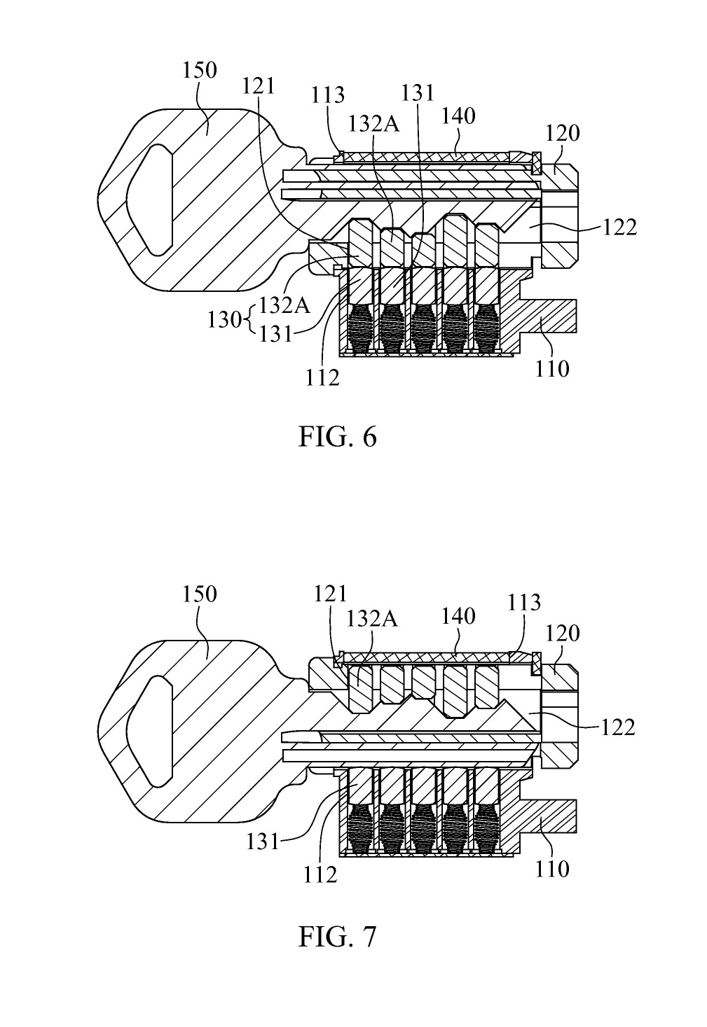

Referring to FIG. 1, the plug hole 111 is in communication with the upper pin holes 112 and the lower-pin-replacing hole 113 respectively. Besides, the upper pin holes 112 and the lower-pin-replacing hole 113 are located at various positions of the lock cylinder 110, in this embodiment, the upper pin holes 112 and the lower-pin-replacing hole 113 are located at opposite positions. The plug 120 is rotatably disposed in the plug hole 111 along a longitudinal axis L of the lock cylinder 110 and the plug 120 comprises a plurality of lower pin holes 121 and a key hole 122 communicated with the lower pin holes 121. The pin assembly 130 comprises a plurality of upper pins 131 and a plurality of lower pins 132. With reference to FIGS. 1 and 6, each of the upper pins 131 is accommodated in each of the upper pins holes 112, and each of the lower pins 132 is accommodated in each of the lower pin holes 121. In this embodiment, referring to FIGS. 6 and 7, the plug 120 is rotatable between a first position and a second position, when the plug 120 is located at the first position, each of the upper pins 131 contacts against each of the lower pins 132, otherwise, when the plug 120 is located at the second position, each of the lower pin holes 121 corresponds to the lower-pin-replacing hole 113 of the lock cylinder 110.

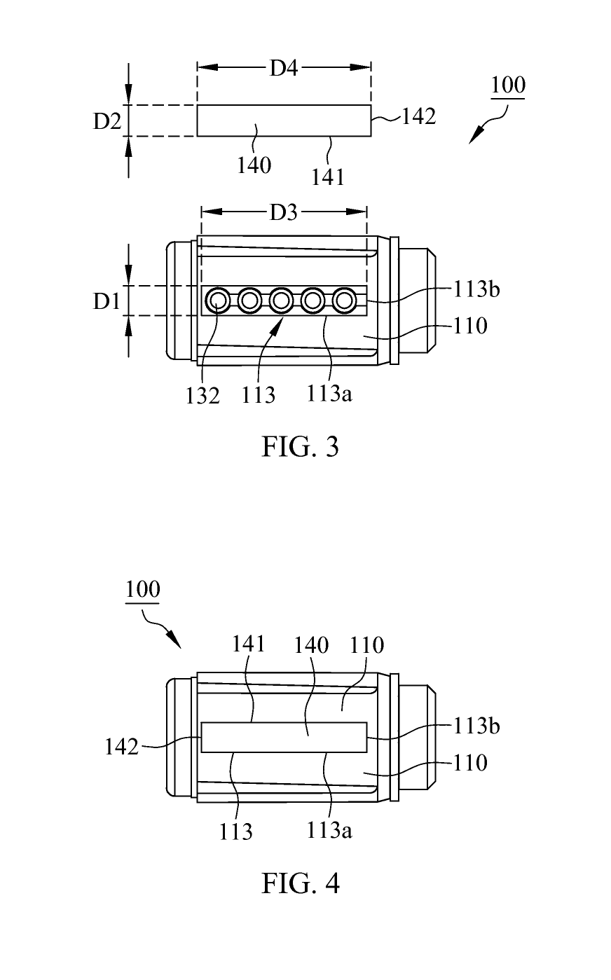

With reference to FIGS. 1, 3 and 4, the stopper 140 is utilized for plugging into the lower-pin-replacing hole 113, in this embodiment, the stopper 140 plugs into the lower-pin-replacing hole 113 in a direction transverse to the longitudinal axis L of the cylinder 110. A peripheral of the stopper 140 is surrounded by the lock cylinder 110 and not revealed by a distal end of the lock cylinder 110. Referring to FIG. 3, the lower-pin-replacing hole 113 comprises a dimension, and the stopper 140 comprises a dimension, in this embodiment, the dimension of the lower-pin-replacing hole 113 is a first width of the lower-pin-replacing hole 113, and the dimension of the stopper 140 is a second width of the stopper 140, wherein the lower-pin-replacing hole 113 comprises a pair of first long surfaces 113a and a pair of first short surfaces 113b, the first width is an interval D1 between the pair of the first long surfaces 113a, or the first width of the lower-pin-replacing hole 113 is an interval D3 between the pair of the first short surfaces 113b. The stopper 140 further comprises a pair of second long surfaces 141 and a pair of second short surfaces 142, each of the second long surfaces 141 corresponds to each of the long surfaces 113a of the lower-pin-replacing hole 113, and each of the second short surfaces 142 corresponds to each of the short surfaces 113b of the lower-pin-replacing hole 113. The second width of the stopper 140 is an interval D2 between the pair of the second long surfaces 141, or the second width of the stopper 140 is an interval D4 between the pair of the second short surfaces 142.

With reference to FIG. 3, when the stopper 140 separates from the lower-pin-replacing hole 113, the second width of the stopper 140 is larger than the first width of the lower-pin-replacing hole 113, which means that the interval D2 is larger than the interval D1, or the interval D4 is larger than the interval D3.

Referring to FIG. 4, when the stopper 140 plugs into the lower-pin-replacing hole 113, the stopper 140 is squeezed into and restricted within the lower-pin-replacing hole 113 so as to make the second width equal to the first width, which means that the interval D2 equals to the interval D1, or the interval D4 equals to the interval D3.

Referring to FIG. 4, owning to the second width of the stopper 140 not smaller than the first width of the lower-pin-replacing hole 113, when the stopper 140 plugs into the lower-pin-replacing hole 113, the stopper 140 contacts against a hole surface of the lower-pin-replacing hole 113 to prevent the stopper 140 from separation from the lower-pin-replacing hole 113.

With reference to FIGS. 3 and 4, the stopper 140 selectively plugs into or separates from the lower-pin-replacing hole 113 so that the lower-pin-replacing hole 113 selectively reveals the lower pins 132. When the stopper 140 plugs into the lower-pin-replacing hole 113, the stopper 140 is utilized to prevent the lower pins 132 from separation from the lower pin holes 121 via the lower-pin-replacing hole 113. When the stopper 140 separates from the lower-pin-replacing hole 113, the lower pins 132 can be replaced via the lower-pin-replacing hole 113.

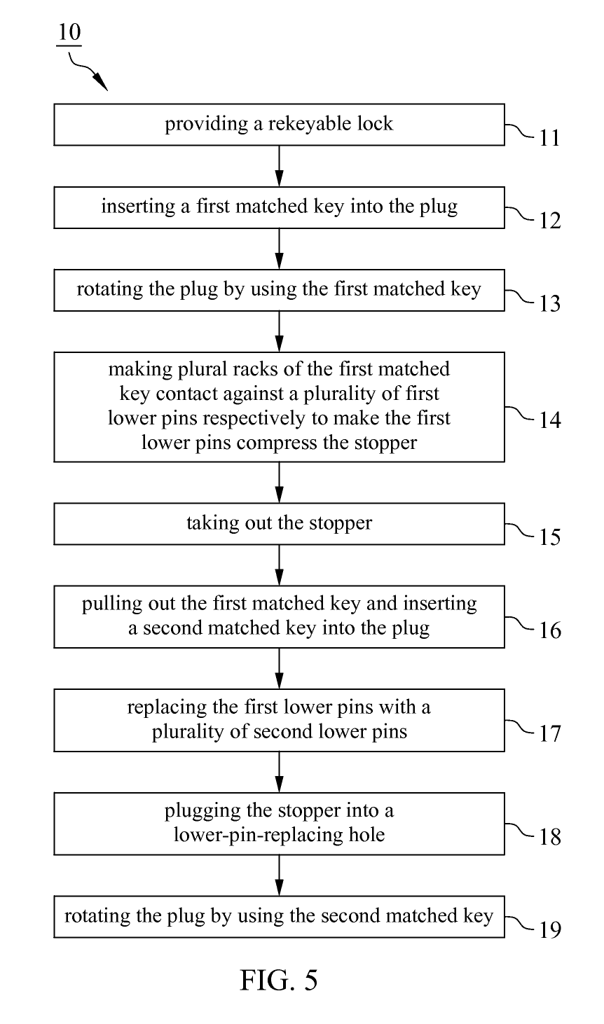

FIG. 5 illustrates an operation flow chart of the rekeyable lock, the operating method for the rekeyable lock includes following steps: providing a rekeyable lock 11; inserting a first matched key into the plug 12; rotating the plug by using the first matched key 13; making plural racks of the first matched key contact against a plurality of first lower pins respectively to make the first lower pins compress the stopper 14; taking out the stopper 15; pulling out the first matched key and inserting a second matched key into the plug 16; replacing the first lower pins with a plurality of second lower pins 17; plugging the stopper into a lower-pin-replacing hole 18; and rotating the plug by using the second matched key 19.

Referring to steps 11, 12 in FIG. 5 and FIG. 6, in the steps of providing a rekeyable lock 100 and inserting a first matched key 150 into the key hole 122 of the plug 120, the first lower pins 132A and the upper pins 133 are compressed by the first matched key 150 to move to a rotation interface.

Referring to step 13 in FIG. 5 and FIG. 7, in the step of rotating the plug 120 to the second position by using the first matched key 150, the lower pin holes 121 correspond to the lower-pin-replacing hole 113. However, for the stopper 140 plugged into the lower-pin-replacing hole 113, the first lower pins 132A do not separate from the lower pin holes 121 via the lower-pin-replacing hole 113.

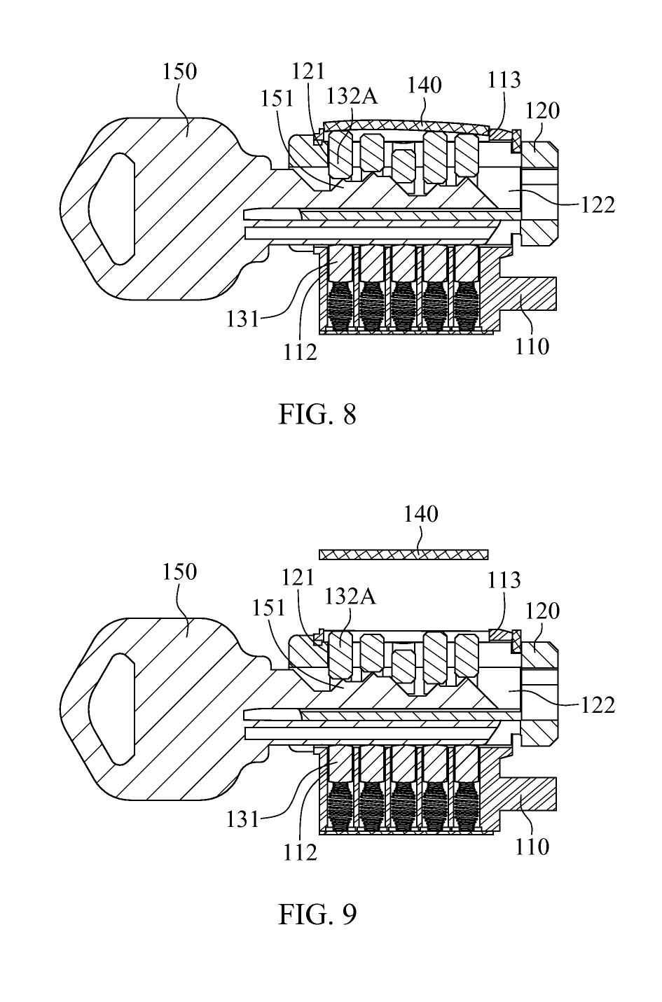

Referring to step 14 in FIG. 5 and FIG. 8, when the plug 120 is located at the second position, with the movement of the first matched key 150 in the plug 120, plural racks 151 of the first matched key 150 contact against the first lower pins 132A respectively to make the first lower pins 132A compress the stopper 140. The stopper 140 is made of elastic material, and the stopper 140 is compressed by the first lower pins 132A to generate a warp so that the stopper 140 can be taken out from the lower-pin-replacing hole 113 successfully.

With reference to step 15 in FIG. 5 and FIG. 9, in the step of taking out the stopper 140 from the lower-pin-replacing hole 113, the lower-pin-replacing hole 113 reveals the first lower pins 132A by taking out the first lower pins 132A favorably.

With reference to step 16 in FIG. 5 and FIGS. 9 and 10, pulling out the first matched key 150 and inserting a second matched key 160 into the plug 120.

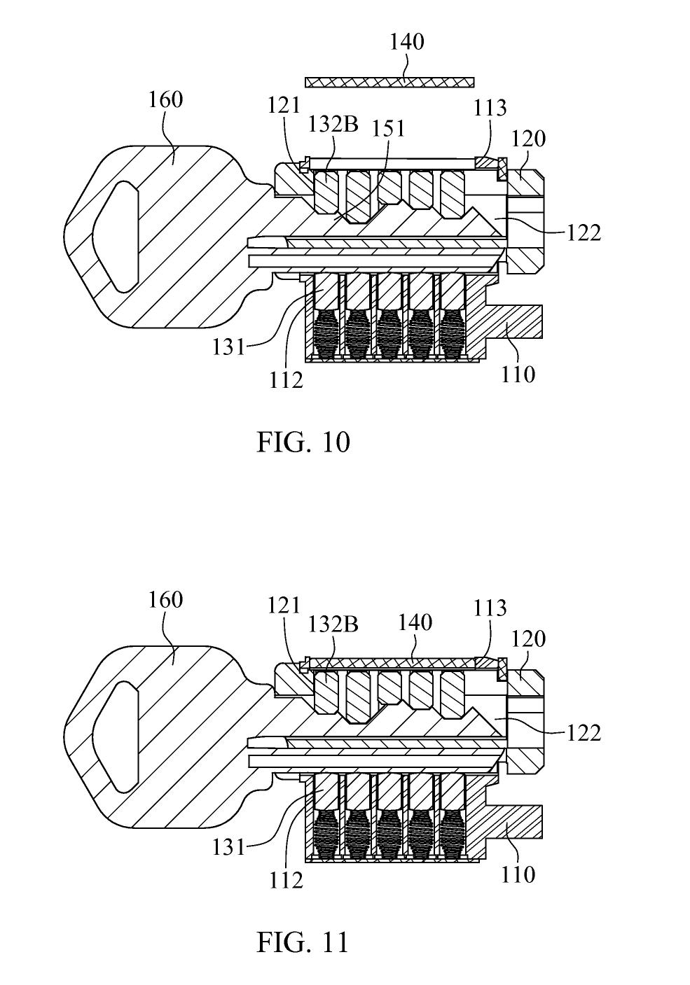

With reference to step 17 in FIG. 5 and FIG. 10, in the step of replacing the first lower pins 132A with a plurality of second lower pins 132B in the lower pin holes 121 via the lower-pin-replacing hole 113, wherein the second matched key 160 is in advance to insert into the key hole 122 of the plug 120 prior to disposing the second lower pins 132B into the lower pins holes 121. Thereafter, determining whether revealed surfaces of the second lower pins 132B disposed in the lower pin holes 121 are coplanar to assure that the second matched key 160 and the second lower pins 132B are matched from each other.

With reference to step 18 in FIG. 5 and FIG. 11, plugging the stopper 140 into the lower-pin-replacing hole 113 is to prevent each of the second lower pins 132B disposed in each of the lower pin holes 121 from separation from the lower-pin-replacing hole 113. Besides, when the second lower pins 132B is rotated in the plug 120, the condition that the second lower pins 132B engaging between the lock cylinder 110 and the plug 120 can be avoidable by blocking the second lower pins 132B via the stopper 140.

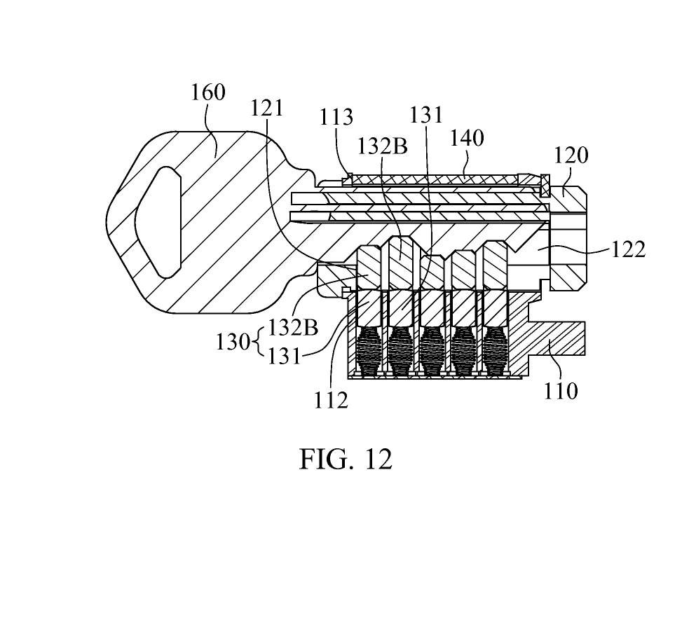

With reference to step 19 in FIG. 5 and FIG. 12, in the step of rotating the plug 120 by using the second matched key 160, each of the lower pin holes 121 corresponds to each of the first upper pin holes 112. Eventually, to draw out the second matched key 160 to complete rekeying operation for the rekeyable lock 100.

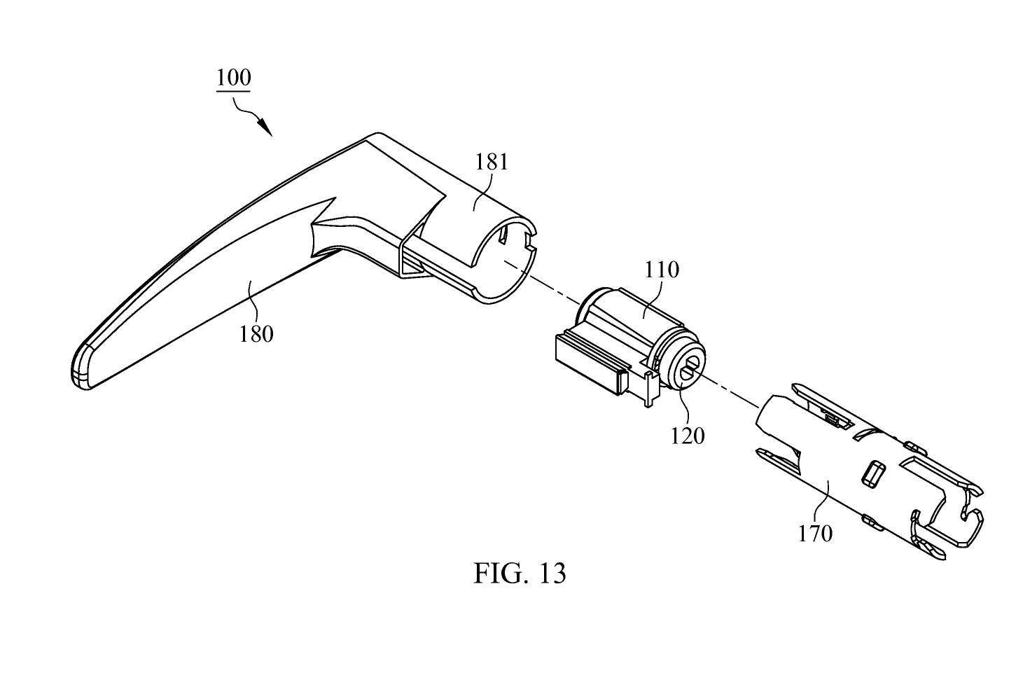

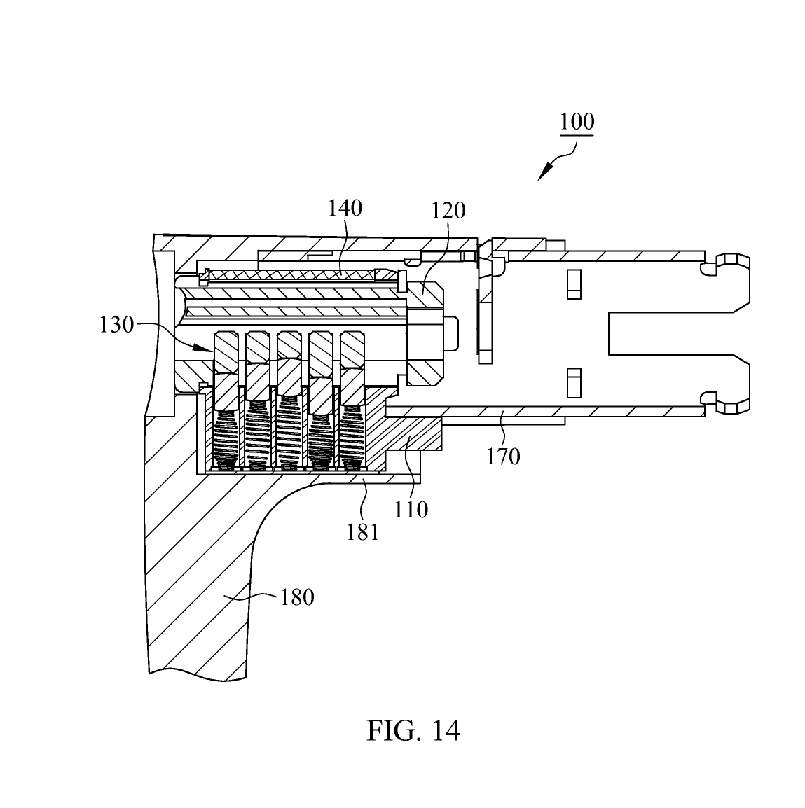

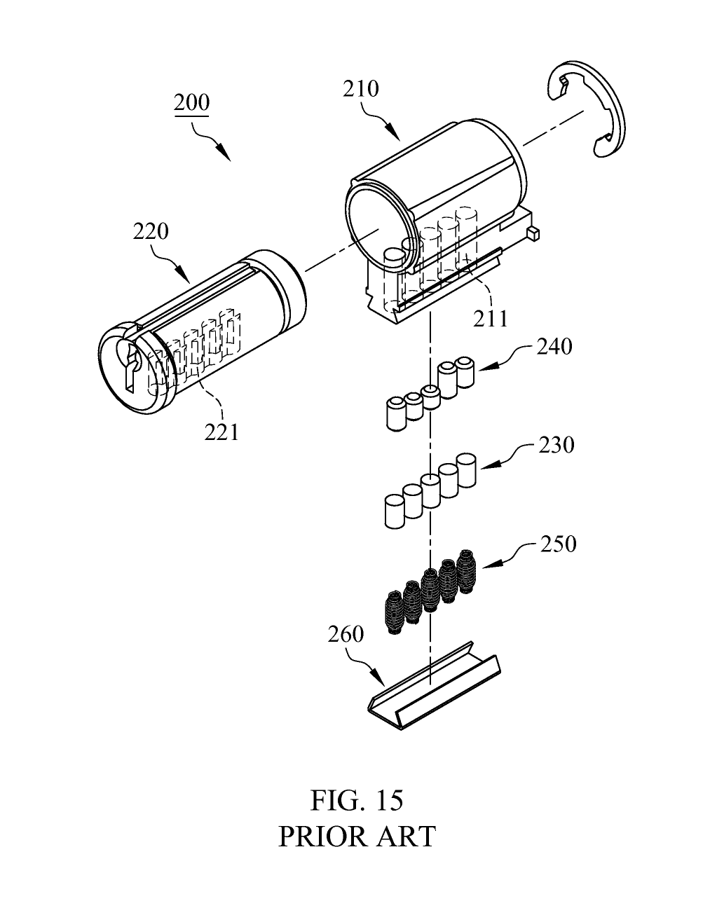

With reference to FIGS. 13 and 14, the rekeyable lock 100 further includes a sleeve 170 and a handle 180 having a rotary portion 181, wherein the lock cylinder 110 is installed at the sleeve 170, and the sleeve 170 is engaged with the rotary portion 181 of the handle 180 to make the sleeve 170, the lock cylinder 110 and the handle 180 act simultaneously.

In this invention, when the stopper 140 separates from the lower-pin-replacing hole 113, the second width of the stopper 140 is larger than the first width of the lower-pin-replacing hole 113, otherwise, when the stopper 140 plugs into the lower-pin-replacing hole 113, the second width of the stopper 140 equals to the first width of the lower-pin-replacing hole 113. Owning to the features mentioned above, the stopper 140 is able to plug into the lower-pin-replacing hole 113. Besides, when the stopper 140 separates from the lower-pin-replacing hole 113, the lower pins 132B can be replaced rapidly therefore reducing rekeying procedure and time.

While this invention has been particularly illustrated and described in detail with respect to the preferred embodiments thereof, it will be clearly understood by those skilled in the art that it is not limited to the specific features and describes and various modifications and changes in form and details may be made without departing from the spirit and scope of this invention.

What is claimed is:

1. A rekeyable lock includes:
a lock cylinder having a plug hole, a plurality of upper pin holes communicated with the plug hole and a lower-pin-replacing hole communicated with the plug hole, the lower-pin-replacing hole comprises a first width;
a plug rotatably disposed in the plug hole and having a plurality of lower pin holes;
a pin assembly having a plurality upper pins and a plurality of lower pins, each of the upper pins is accommodated in each of the upper pin holes, each of the lower pins is accommodated in each of the lower pin holes, the lower-pin-replacing hole selectively reveals the lower pins; and
a stopper utilized for plugging into the lower-pin-replacing hole and having a second width not smaller than the first width.

2. The rekeyable lock in accordance with claim 1, wherein the stopper selectively plugs into or separates from the lower-pin-replacing hole, when the stopper plugs into the lower-pin-replacing hole, the first width equals to the second width, when the stopper separates from the lower-pin-replacing hole, the second width is larger than the first width.

3. The rekeyable lock in accordance with claim 2, wherein the lower-pin-replacing hole comprises a pair of first long surfaces and a pair of first short surfaces, the stopper comprises a pair of second long surfaces and a pair of second short surfaces, the first width is an interval between the pair of first long surfaces, and the second width is an interval between the pair of second long surfaces.

4. The rekeyable lock in accordance with claim 2, wherein the lower-pin-replacing hole comprises a pair of first long surfaces and a pair of first short surfaces, the stopper comprises a pair of second long surfaces and a pair of second short surfaces, the first width is an interval between the pair of first short surfaces, and the second width is an interval between the pair of second short surfaces.

5. The rekeyable lock in accordance with claim 1, wherein each of the upper pin holes and the lower-pin-replacing hole are located at various positions of the lock cylinder.

6. The rekeyable lock in accordance with claim 1, wherein the plug is disposed in the plug hole along a longitudinal axis of the lock cylinder, and the stopper plugs into the lower-pin-replacing hole in a direction transverse to the longitudinal axis.

7. The rekeyable lock in accordance with claim 1 further includes a sleeve and a handle, the lock cylinder is installed at the sleeve, and the sleeve is engaged with a rotary portion of the handle.

8. The rekeyable lock in accordance with claim 1, wherein the plug is rotatable between a first position and a second position, when the plug is located at the first position, each of the upper pins contacts against each of the lower pins, when the plug is located at the second position, each of the lower pin holes corresponds to the lower-pin-replacing hole of the lock cylinder.

9. The rekeyable lock in accordance with claim 8, wherein when the plug is located at the second position, with the movement of a matched key in the plug, plural racks of the matched key contact against the lower pins to make the lower pins compress the stopper and enables the stopper to generate a warp.

10. The rekeyable lock in accordance with claim 1, wherein when the stopper plugs into the lower-pin-replacing hole, a peripheral of the stopper is surrounded by the lock cylinder, and the peripheral of the stopper is not revealed by a distal end of the lock cylinder.

11. A rekeyable lock includes:
a lock cylinder having a plug hole, and a lower-pin-replacing hole communicated with the plug hole;
a pin assembly having a plurality of lower pins;
a plug rotatably disposed in the plug hole and having a plurality of lower pin holes, wherein each of the lower pins is accommodated in each of the lower pin holes; and
a stopper, wherein the dimension of the stopper is not smaller than the dimension of the lower-pin-replacing hole so that the stopper is plugged into the lower-pin-replacing hole to prevent each of the lower pins separate from each of the lower pin holes when the plug is rotatable to a position where each of the lower pin holes corresponds to the lower-pin-replacing hole.

12. The rekeyable lock in accordance with claim 11, wherein the stopper selectively plugs into or separates from the lower-pin-replacing hole, when the stopper plugs into the lower-pin-replacing hole, the dimension of the stopper equals to the dimension of the lower-pin-replacing hole, when the stopper separates from the lower-pin-replacing hole, the dimension of the stopper is larger than the dimension of the lower-pin-replacing hole.

13. The rekeyable lock in accordance with claim 12, wherein the lower-pin-replacing hole comprises a pair of first long surfaces and a pair of first short surfaces, the stopper comprises a pair of second long surfaces and a pair of second short surfaces, the dimension of the lower-pin-replacing hole is an interval between the pair of first long surfaces, and the dimension of the stopper is an interval between the pair of second long surfaces.

14. The rekeyable lock in accordance with claim 12, wherein the lower-pin-replacing hole comprises a pair of first long surfaces and a pair of first short surfaces, the stopper comprises a pair of second long surfaces and a pair of second short surfaces, the dimension of the lower-pin-replacing hole is an interval between the pair of first short surfaces, and the dimension of the stopper is an interval between the pair of second short surfaces.

15. The rekeyable lock in accordance with claim 11 further includes a sleeve and a handle, the lock cylinder is installed at the sleeve, and the sleeve is engaged with a rotary portion of the handle.

16. The rekeyable lock in accordance with claim 11, wherein when the plug is located at the position where each of the lower pin holes corresponds to the lower-pin-replacing hole, with the movement of a matched key in the plug, plural racks of the matched key contact against the lower pins to make the lower pins compress the stopper and enables the stopper to generate a warp.

17. The rekeyable lock in accordance with claim 11, wherein when the stopper plugs into the lower-pin-replacing hole, a peripheral of the stopper is surrounded by the lock cylinder, and the peripheral of the stopper is not revealed by a distal end of the lock cylinder.

18. The rekeyable lock in accordance with claim 11, wherein the plug is disposed in the plug hole along a longitudinal axis of the lock cylinder, and the stopper plugs into the lower-pin-replacing hole in a direction transverse to the longitudinal axis.
